(19) United States
(12) Patent Application Publication
(10) Pub. No.: US 2018/0157651 A1
(43) Pub. Date: Jun. 7, 2018

(54) Auditing Lineage of Consumer Data Through Multiple Phases of Transformation

(71) Applicant: Quaero, Charlotte, NC (US)

(72) Inventors: Dan Smith, Cornelius, NC (US); Dan Bonfili, Charlotte, NC (US)

(73) Assignee: Quaero, Charlotte, NC (US)

(21) Appl. No.: 15/830,090

(22) Filed: Dec. 4, 2017

Related U.S. Application Data
(60) Provisional application No. 62/430,379, filed on Dec. 6, 2016.

(51) Int. Cl. G06F 17/30

(52) U.S. Cl. CPC G06F 17/301; G06F 17/30864; G06F 17/3012

(57) ABSTRACT

This invention presents a method for tracking data through complex data transformation lineages, and storing metadata about the lineage and execution of transformations in metadata for tracing and auditing purposes post-execution. The method described is particularly effective on tabular data (rows and columns) and is particularly applicable to consumer data for the purposes of governance and data protection, usage and privacy regulation compliance.

### CROSS-REFERENCE TO RELATED APPLICATION

This application claims domestic benefit of U.S. Provisional Application 62/430,379 filed Dec. 6, 2016 and incorporated herein by reference in its entirety.

### BACKGROUND

The number of disparate sources of consumer data has dramatically increased over the last two decades, largely due to the growth of the internet, and the proliferation and accessibility of connected digital devices. Consolidation of disparate data sources can yield a comprehensive understanding of consumers; their attributes, behaviors, locations, interests, and tendencies. Many applications rely on such a comprehensive understanding of consumers. Applications include, but are not limited to, advertising, marketing, customer service, fraud, and homeland security. However, consolidating data from disparate sources breeds challenges. One such challenge is auditing. To illustrate, data must be moved from its origin to a central location, merged with other data originating from different sources and then typically processed through multiple transformations. Moreover, many transformations change the cardinality of the originally received data; one record can transform into many, and many records can transform into one. These “transformations” physically blend similar and dissimilar data elements to derive new data elements. To further complicate matters, derived data elements are often blended with other derived data elements. The result is a series of derived data elements which often have little or no resemblance to its original source data elements. Auditing transformations enables the ability to answer questions like “where did this data come from?” and “where did this data go?”. These answers are necessary for effective data governance, and in many cases, required for compliance with regulations governing data protection, privacy and usage. This invention presents a method for using attributional metadata to effectively audit lineage of consumer data through multiple phases of transformation.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a diagram of a directed acyclic graph, upon which the core concepts of the exemplary embodiments are based;

FIG. 2 is an example of a data lineage visualization, which is based on the principles of a directed acyclic graph;

FIG. 3 is a diagram illustrating the metadata schema used by exemplary embodiments to represent workflow definitions and data definitions whose relationships to each other comprise data lineage;

FIG. 4 is a diagram illustrating a transformation of one record into many;

FIG. 5 is a diagram illustrating a transformation of many records into one;

FIG. 6 is a diagram illustrating use of cohort dataset instance identifiers (values in “dataset_instance_id” related columns) whose recordation in data store tables provides linkage to the respective workflow and dataset instance metadata (tracked in the metastore) responsible for the “many to many record” transformation;

FIG. 7 is a diagram representing schema defined in the metastore used by exemplary embodiments to track significant workflow and dataset instance attributes as well as relationships between workflow instance identifiers (“workflow_instance_id” column values) and their corresponding input/output cohort dataset instance identifiers (“dataset_instance_id” column value and “dataset_instance_direction” values);

FIG. 8 is example of declaratively expressed transformation logic snapshotted at time of execution;

FIG. 9 is a process flow diagram illustrating the runtime generation, execution and historical capture of all attributional metadata (cohort dataset instance identifiers, workflow transformation instance identifiers, respective relationships, as well as persistence of snapshot of transformation logic) through the directed acyclic graph; and

FIG. 10 illustrates an operating environment, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

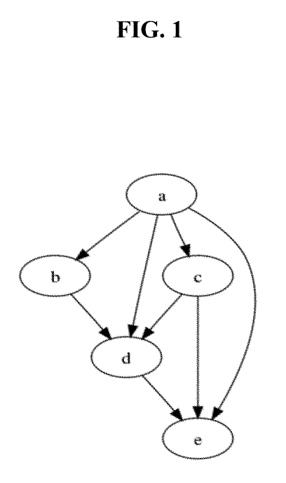

FIG. 1 is a diagram of a directed acyclic graph. An understanding of the directed acyclic graph is fundamental to an understanding of how instances of data flow through the various transformations of the data consolidation platform, which is fundamental to the exemplary embodiments. In FIG. 1, the vertices (1) represent data stores, hereafter referred to as datasets. A dataset represents a file, table, stream, rows, or any other abstraction or permutation of a data storage construct. The edges (2) represent transformation processes which move and/or transform data, hereafter referred to as workflows. It is significant that the graph is directed, in that the data flow is assumed to be directional (and thus “upstream” and “downstream” metaphors apply), and acyclic in that the data flow is not recursive.

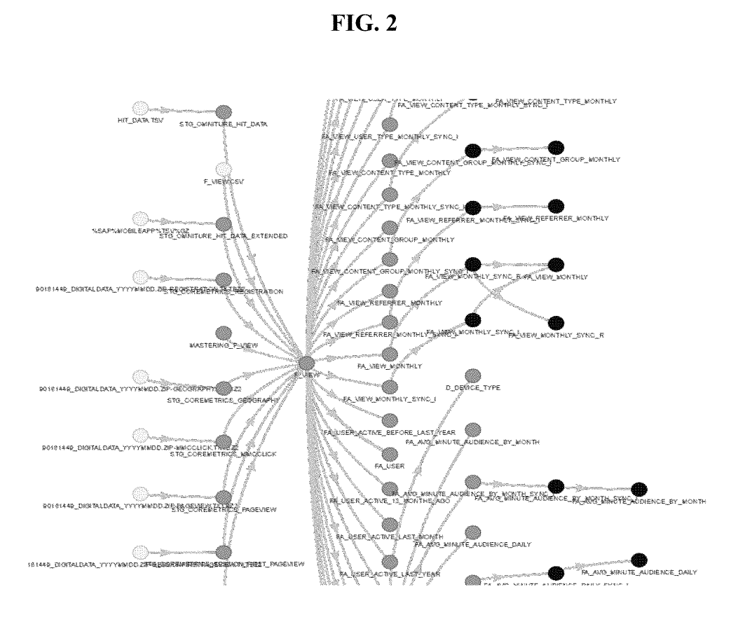

FIG. 2 is an illustration of example datasets flowing through example workflows based on the directed acyclic graph model. Note that there are examples of workflows (edges) transforming multiple datasets (vertices) into one dataset, and conversely, examples of multiple workflows transforming one dataset into multiple datasets.

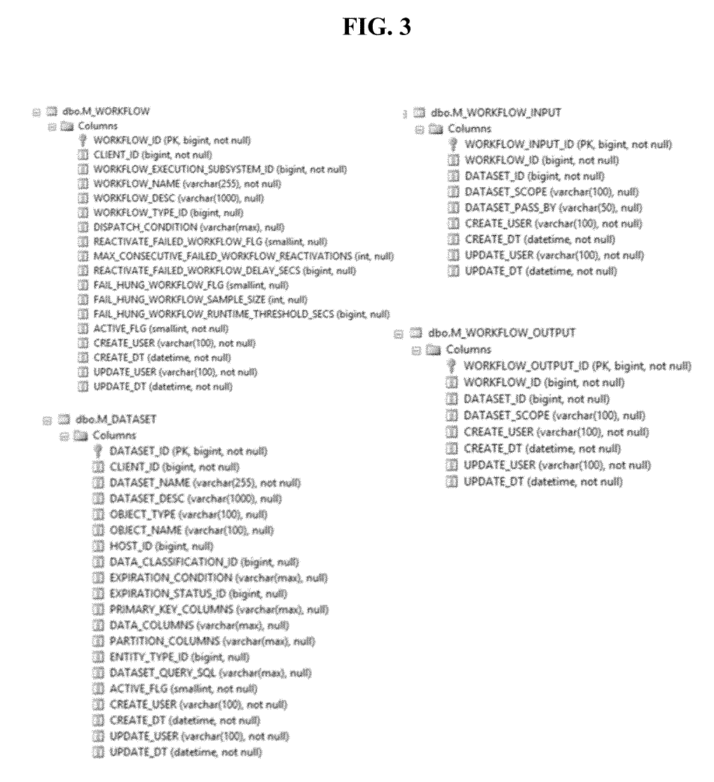

For the exemplary embodiments to enable data flow through various datasets by way of workflows illustrated in FIG. 2, the dataset and workflow entities, and their relationships, must be represented in some form that can be read and analyzed. Exemplary embodiments represent these entities in a metadata schema which is partially illustrated in FIG. 3.

When the data presented to the system is tabular, that is, represented as rows and columns, a splitting (one to many) and merging (many to one) phenomenon can occur at the cell and row level, in addition to the dataset level. While exemplary embodiments address non-tabular data as well as tabular data, because the vast majority of consumer data processed today is tabular, and because tabular data presents additional challenges that exemplary embodiments address, the remainder of this disclosure will focus on tabular data.

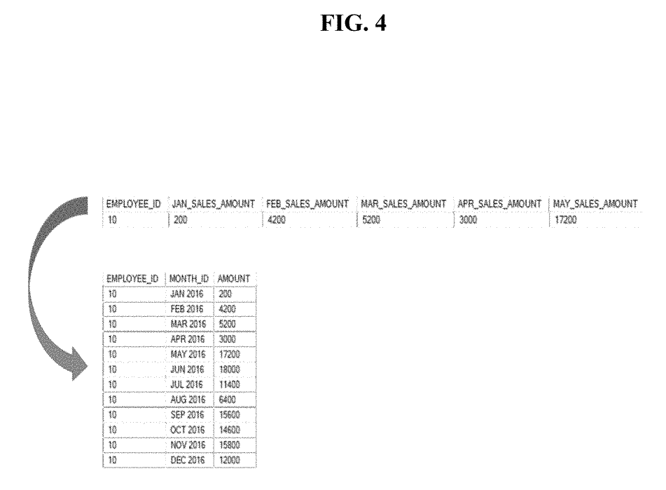

FIG. 4 is an illustration of how many rows in a table can be transformed into one row in another table. Examples of this include but are not limited to, aggregation (e.g. grouping many rows on a subset of columns and applying calculations such as sum, average, min, max etc. to other columns), and de-normalization, or pivoting (transforming values from multiple rows into multiple columns in one row).

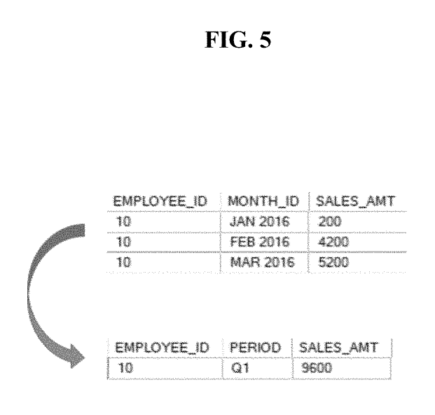

FIG. 5 is an illustration of how one row in a table can be transformed into many rows in another table. Examples of this include but are not limited to, splitting records (e.g. creating two records and moving half the fields to one record and the other half to the other record), and normalization, or un-pivoting (e.g. creating separate rows for each column, using a single additional field to represent the meaning of the source column).

In both cases just described, the transformation changes the cardinality of the data, and this presents a challenge for simple tracking methods. For example, a simple method to track data is to assign a row identifier, for example, in a field on each row of a table, and then carry that row identifier through the various transformations into other tables. This works only if the cardinality of all tables remains the same; each row in Table A has one and only one counterpart row in Table B, post transformation. While this is true with very simple transformations, it is often not true for more complex transformations.

Exemplary embodiments address such challenges by relying upon two abstractions recognized by the data consolidation platform: “workflow instances” and “dataset instances”. A dataset instance represents a specific chunk of data whose existence emanated from the execution of a data transformation task. A workflow instance is an entity whose existence results from the compiling and dispatching of instructions to accomplish a data transformation task. A workflow instance is an entity composed of dynamic variables resolved at run-time in conjunction with metadata values copied from the schema entities illustrated in FIG. 3.

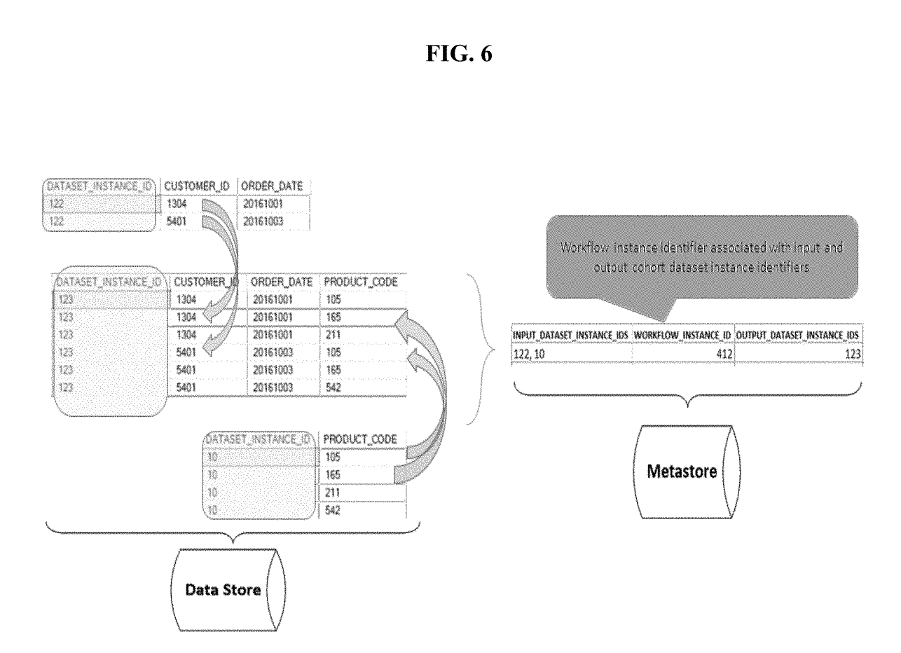

The consolidation platform tracks the details of dispatched workflow instances by assigning a globally unique value (known as “transformation workflow instance identifier”) to each workflow instance entity. The consolidation platform also tracks the details of dataset instances by assigning a globally unique value (known as “cohort dataset instance identifier”) to each dataset instance entity. A dataset instance (aka chunk of data) is a cohort by virtue of its lifecycle emanating from the same workflow instance. The physical data resulting from the execution of the workflow instance includes its assigned cohort data instance identifier. This cohort data instance identifier value is physically stored in a column named dataset_instance_id within the target table (aka dataset) affected by the workflow instance. Within this model, one or more rows in an input table, each with its corresponding dataset instance identifier, can be transformed into new cohort of rows in an output table, and all resulting rows from transformation are assigned the new cohort dataset instance identifier value. As such, exemplary embodiments can track sets of input rows through transformations into a set of output rows, thus addressing the more complex transformations which change the cardinality of the data as illustrated in FIG. 6.

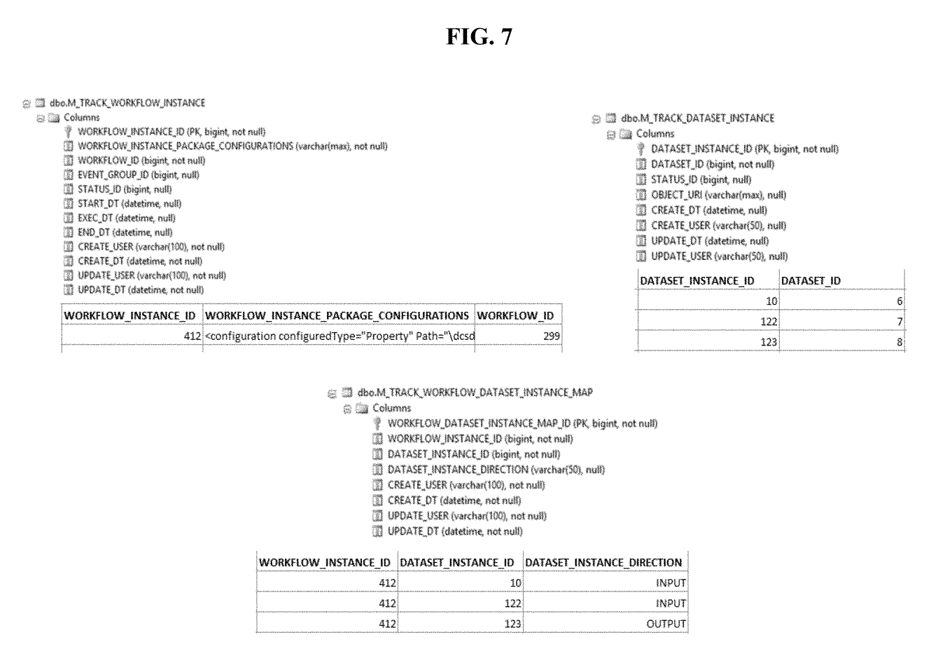

FIG. 7 illustrates schema entities used by exemplary embodiments to track the lifecycle of workflow instances as well as corresponding input and output dataset instances. Each dispatched workflow instance relies upon referencing one or more input dataset instances in conjunction with provided data transformation logic to yield one or more output dataset instances. The lifecycle tracking afforded by the schema entities provides for traceability and auditing post-execution.

It should be noted that this technique does not provide for lineage tracking of instances of individual cells or rows. For example, it does not provide the ability to trace a specific cell of data through transformations to another specific cell of data. While this is theoretically possible, exemplary embodiments do not address this, because of the additional processing and storage costs that would be required. Exemplary embodiments provide for lineage tracking for tables, and for cohorts of rows within the tables. Exemplary embodiments also provide for capturing a snapshot of the transformation logic at the time of execution. Foundational to exemplary embodiments is the assertion that with these three things, necessary and sufficient auditing lineage of consumer data through multiple phases of transformation can be accomplished, and can be accomplished with minimal overhead.

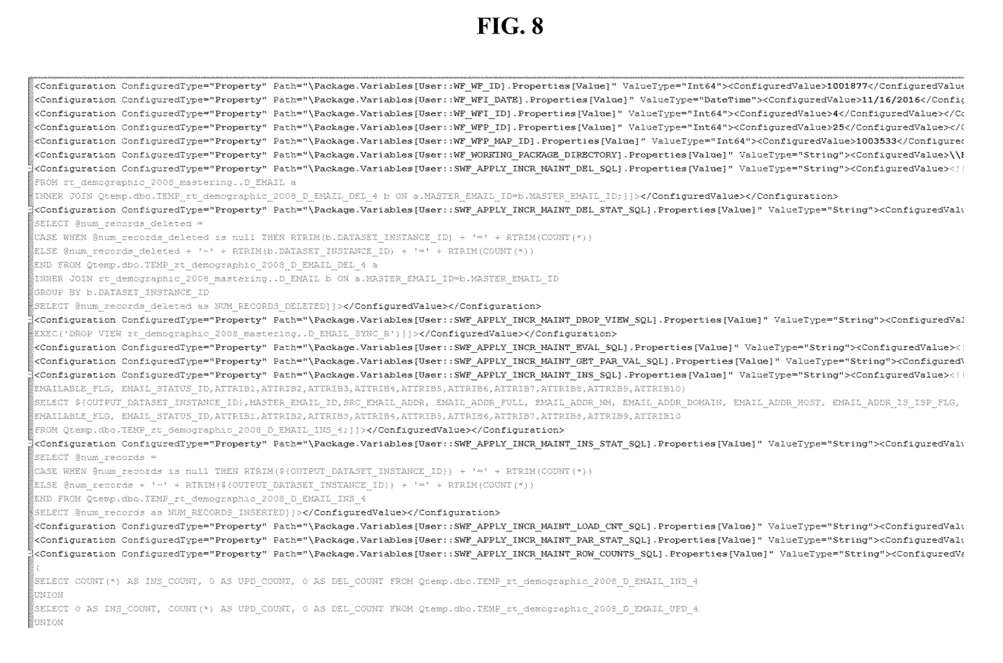

It is common for transformation logic defined in metadata schema entities (FIG. 3) to change over time due to several factors. Hence, transformation logic for a given workflow definition can effectively change between executions. To illustrate, assume a workflow definition (ID 10) is dispatched and executed on Nov. 1, 2016, resulting in a lifecycle of workflow instance with an assigned instance identifier value of 15. On Nov. 2, 2016, the definition for the same workflow (ID 10) is updated. On Nov. 3, 2016, workflow (ID 10) is dispatched and executed, resulting in a lifecycle of yet another workflow instance with an assigned instance identifier value of 23. This scenario yields workflow (ID 10) having two different workflow instances (instance identifier values 15 and 23 respectively) yet their executed instructions were slightly different. Exemplary embodiments address this challenge by capturing a snapshot of the compiled workflow instance transformation instructions used for execution. The snapshot is persisted and associated with the workflow instance record. This illustrated in FIG. 8.

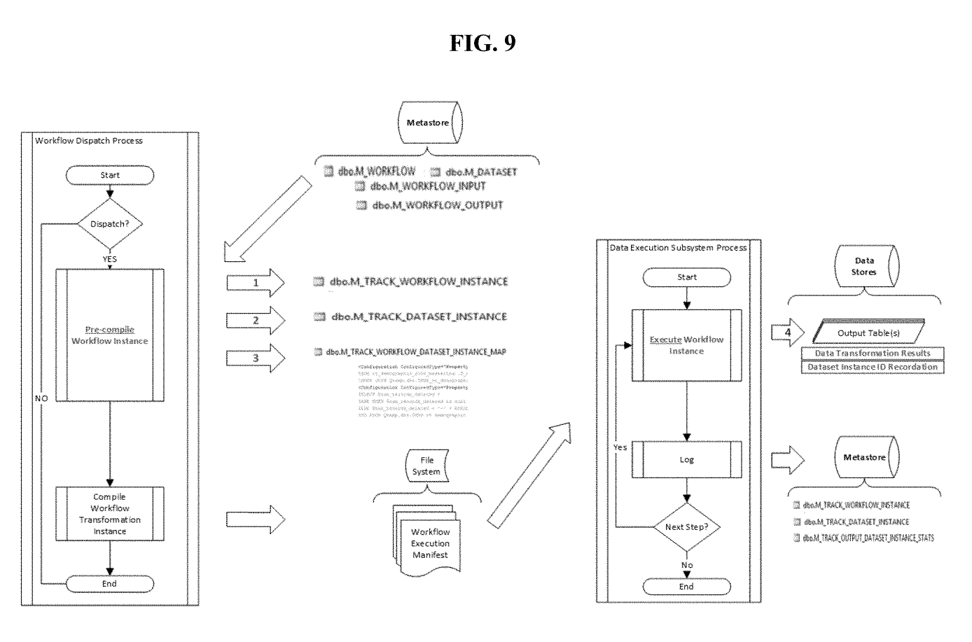

In order to facilitate the capture of transformation logic, exemplary embodiments express the workflow lineage and transformation logic within them with a declarative language. All datasets, workflows and the relationships between them are expressed in a declarative language which is pre-compiled at runtime to resolve dynamic and temporal variables. The output of the pre-compiler is fully resolved, and sufficient to describe the lineage and transformations within them with enough precision to support governance and compliance requirements. The pre-compiler output is captured as a snapshot, associated with the transformation workflow instance identifier and stored permanently in the metadata schema. An example of the pre-compiler output is shown in FIG. 8. The pre-compiler output is then processed by a compiler which generates the machine executable version that is transmitted to the appropriate environment for execution. This process flow is illustrated in FIG. 9. This results in the capture and storage of several data elements which facilitate tracing and auditing post-transformation workflow instance execution:
1. Transformation workflow instance attributes, such as identifier, status, and timestamp
2. Cohort dataset instance attributes, such as identifier, status and timestamp
3. Snapshot of declarative transformation logic as well as relationships between the transformation workflow instance identifier and related input cohort dataset instance identifiers and resulting output cohort dataset instance identifiers.
4. Recordation of cohort dataset instance identifiers on each row affected by the transformation workflow instance; this provides linkage between the actual data and the tracking metadata.

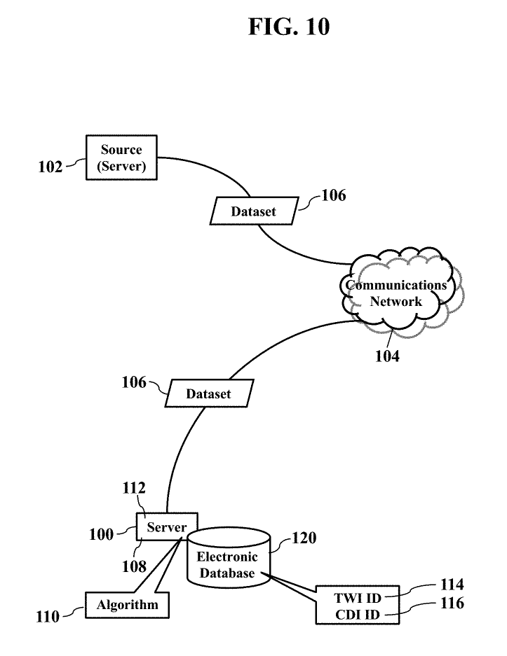

FIG. 10 illustrates an operating environment, according to exemplary embodiments. FIG. 10 illustrates a server 100 communicating with any source 102 via a communications network 104. As this disclosure explains, the source 102 may provide one or multiple electronic datasets 106 as inputs. The server 100 has a processor 108, application specific integrated circuit (ASIC), or other component that executes an algorithm 110 stored in a local memory device 112. The algorithm 110 instructs the processor 108 to perform operations, such as performing a cloud-based service in response to a request sent from the source 102. The server 100 performs one or more transformations on data contained within the electronic dataset 106. The server 100 may assign the transformation workflow instance identifier (or “TWI ID”) 114 to each transformation of the electronic dataset 106. The server 100 may additionally or alternatively assign the cohort dataset instance identifier (or “CDI ID”) 116 to each transformation of the electronic dataset 106. The server 100 may generate metadata describing the transformation workflow instance identifier 114 and/or the cohort dataset instance identifier 116. The server 100 may then add the metadata as entries to an electronic database 120. The electronic database 120 electronically associates the metadata to the transformation of the electronic dataset 106. The server 100 may then send the metadata via the communications network 104 to the source 102 as a result or response to the cloud-based service. At any subsequent time, the server 100 may query the electronic database 120 and to retrieve or identify matching or non-matching database entries. For example, the electronic database 120 may have entries that electronically associate the metadata to the corresponding transformation. The electronic database 120 may thus electronically associate the transformation workflow instance identifier 114 and/or the cohort dataset instance identifier 116 to the corresponding transformation performed on the electronic dataset 106. Whenever the transformations are audited, the electronic database 120 may be queried for the corresponding transformation workflow instance identifier 114 and/or the cohort dataset instance identifier 116 (or vice-versa). No matter how, or how many times, the electronic dataset 106 is transformed, its input and output data may be traced via the metadata describing the transformation workflow instance identifier 114 and/or the cohort dataset instance identifier 116.

Exemplary embodiments may be utilized in any operating environment. For example, the server 100 storing the electronic database 120 may perform row transformation, consolidate workflows, and generate snapshots of declarative transformation logic (as above explained). The algorithm 110 instructs the processor 108 to perform operations via a network interface to the communications network 104. Information may be received as packets of data according to a packet protocol (such as any of the Internet Protocols). The packets of data contain bits or bytes of data describing the contents, or payload, of a message. A header of each packet of data may contain routing information identifying an origination address and/or a destination address. The algorithm 110, for example, may instruct the processor 108 to inspect packetized information for network addresses (e.g., IP address), cellular identifiers (e.g., telephone number, MSISDN), and/or any other data contained within header or payload.

Exemplary embodiments may be applied regardless of networking environment. Exemplary embodiments may be easily adapted to stationary or mobile devices having cellular, WI-FI®, near field, and/or BLUETOOTH° capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations”, this could include the processor performing the operations directly and/or facilitating, directing, or cooperating with another device or component to perform the operations.

1. A method, comprising:
receiving, by a server, an electronic dataset sent via the Internet from a source, the electronic dataset comprising a logical representation of data transformation lineage in metadata modeled as a directed acyclic graph;
generating, by the server, a transformation of the electronic dataset;
assigning, by the server, a transformation workflow instance identifier to the transformation of the electronic dataset;
assigning, by the server, a cohort dataset instance identifier to the transformation of the electronic dataset;
generating, by the server, additional metadata describing the transformation workflow instance identifier assigned to the transformation of the electronic dataset;
generating, by the server, the additional metadata describing the cohort dataset instance identifier assigned to the transformation of the electronic dataset; and
adding, by the server, the additional metadata as entries to an electronic database, the electronic database electronically associating the additional metadata to the transformation of the electronic dataset;
wherein the additional metadata tracks the transformation of the electronic dataset.

2. The method of claim 1, further comprising capturing a declarative representation of programming logic executed to generate the transformation of the electronic dataset.

3. The method of claim 2, further comprising adding the declarative representation of the programming logic to the electronic database, the electronic database electronically associating the additional metadata to the declarative representation of the programming logic.

4. The method of claim 3, further comprising querying the electronic database post-execution for the additional metadata.

5. The method of claim 4, further comprising identifying the declarative representation of the programming logic that is electronically associated with the additional metadata.

6. The method of claim 1, further comprising querying the electronic database for the additional metadata and identifying the transformation workflow instance identifier that is electronically associated with the additional metadata. The method of claim 1, further comprising querying the electronic database for the additional metadata and identifying the cohort dataset instance identifier that is electronically associated with the additional metadata.

8. The method of claim 1, further comprising logging multiple transformation workflow instance identifiers associated with multiple transformations of the electronic dataset, each one of the multiple transformation workflow instance identifiers assigned to a corresponding transformation of the multiple transformations of the electronic dataset.

9. The method of claim 1, further comprising logging multiple cohort dataset instance identifiers associated with multiple transformations of the electronic dataset, each one of the multiple cohort dataset instance identifiers assigned to a corresponding transformation of the multiple transformations of the electronic dataset.

10. The method of claim 1, further comprising transforming a tabular row of data within the electronic dataset into a tabular column of the data.

11. The method of claim 1, further comprising transforming multiple tabular rows of data within the electronic dataset into a single tabular column of the data.

12. The method of claim 1, further comprising transforming a tabular column of data within the electronic dataset into a tabular row of the data.

13. The method of claim 1, further comprising transforming multiple tabular columns of data within the electronic dataset into a single tabular row of the data.

14. The method of claim 1, further comprising adding the transformation workflow instance identifier as a columnar entry to the electronic database.

15. The method of claim 1, further comprising adding the transformation workflow instance identifier as one of the entries in a row of the electronic database.

16. The method of claim 1, further comprising adding the cohort dataset instance identifier as a columnar entry to the electronic database.

17. The method of claim 1, further comprising adding the cohort dataset instance identifier as one of the entries in a row of the electronic database.

18. The method of claim 1, further comprising assigning the cohort dataset instance identifier to track an input row transformed to an output row.

19. A system, comprising:
a hardware processor; and
a memory device, the memory device storing instructions, the instructions when executed causing the hardware processor to perform operations, the operations comprising:
receiving a request for a cloud-based auditing service sent via the Internet from a client device, the request comprising an electronic dataset expressed as a logical representation of data transformation lineage in metadata modeled as a directed acyclic graph;
generating a transformation of the electronic dataset;
assigning a transformation workflow instance identifier to the transformation of the electronic dataset;
assigning a cohort dataset instance identifier to the transformation of the electronic dataset;
generating additional metadata describing the transformation workflow instance identifier assigned to the transformation of the electronic dataset;
generating the additional metadata describing the cohort dataset instance identifier assigned to the transformation of the electronic dataset;
adding the additional metadata as entries to an electronic database, the electronic database electronically associating the additional metadata to the transformation of the electronic dataset; and
sending the additional metadata via the Internet to the client device as a response to the request for the cloud-based auditing service;
wherein the additional metadata allows auditing of the transformation of the electronic dataset.

20. A memory device storing instructions that when executed cause a hardware processor to perform operations, the operations comprising:
receiving a request for a cloud-based auditing service sent via the Internet from a client device, the request comprising an electronic dataset expressed as a logical representation of data transformation lineage in metadata modeled as a directed acyclic graph;
generating a transformation of the electronic dataset;
assigning a transformation workflow instance identifier to the transformation of the electronic dataset;
assigning a cohort dataset instance identifier to the transformation of the electronic dataset;
generating additional metadata describing the transformation workflow instance identifier assigned to the transformation of the electronic dataset;
generating the additional metadata describing the cohort dataset instance identifier assigned to the transformation of the electronic dataset;
adding the additional metadata as entries to an electronic database, the electronic database electronically associating the additional metadata to the transformation of the electronic dataset; and
sending the additional metadata via the Internet to the client device as a response to the request for the cloud-based auditing service;
wherein the additional metadata allows auditing of the transformation of the electronic dataset.
